(19) United States
(12) Patent Application Publication
(10) Pub. No.: US 2023/0059278 A1
(43) Pub. Date: Feb. 23, 2023

(54) NON-AQUEOUS ELECTROLYTIC SOLUTION SECONDARY BATTERY

(71) Applicant: PANASONIC INTELLECTUAL PROPERTY MANAGEMENT CO., LTD., Osaka-shi, Osaka (JP)

(72) Inventors: Keisuke Asaka, Osaka Fu (JP); Takuji Tsujita, Osaka Fu (JP); Motohiro Sakata, Osaka Fu (JP)

(73) Assignee: PANASONIC INTELLECTUAL PROPERTY MANAGEMENT CO., LTD., Osaka-shi, Osaka (JP)

(21) Appl. No.: 17/795,684

(22) PCT Filed: Jan. 21, 2021
(86) PCT No.: PCT/JP2021/001962

§ 371 Date: Jul. 27, 2022

(30) Foreign Application Priority Data
Jan. 30, 2020 (JP) 2020-014237

(51) Int. Cl. H01M 4/62; H01M 10/0568; H01M 10/0569; H01M 10/0525; H01M 10/0567; H01M 4/04; H01M 4/525

(52) U.S. Cl. CPC H01M 4/62; H01M 10/0568; H01M 10/0569; H01M 10/0525; H01M 10/0567; H01M 4/0404; H01M 4/525; H01M 2004/028

(57) ABSTRACT

A nonaqueous electrolyte secondary battery includes a positive electrode having a positive electrode mixture layer, a negative electrode, and a nonaqueous electrolyte, wherein the positive electrode mixture layer includes a positive electrode active material and inactive particles, the positive electrode active material includes a lithium-containing composite oxide, an average particle size D1 of the positive electrode active material and an average particle size D2 of the inactive particles satisfy D1>D2, and a viscosity at 30° C. of the nonaqueous electrolyte is less than 2 mPa·s.

### TECHNICAL FIELD

The present disclosure relates to a nonaqueous electrolyte secondary battery.

### BACKGROUND ART

Nonaqueous electrolyte secondary batteries represented by lithium ion secondary batteries include a positive electrode, a negative electrode, and an electrolyte, and the positive electrode includes a positive electrode active material.

Patent Literature 1 teaches a nonaqueous electrolyte secondary battery including a positive electrode plate having a positive electrode mixture layer containing a positive electrode active material, a negative electrode plate, and a nonaqueous electrolyte containing an electrolytic salt in a nonaqueous solvent, wherein the positive electrode active material is a lithium nickel composite oxide represented by LiₓNi_{1-y}M_{y}O_{z} (0.9<x≤1.2, 0<y≤0.7, 1.9<z≤2.1, M is an element including at least one of Al and Co), particles of ceramics adhere to the surfaces of the positive electrode active material particles, and the positive electrode mixture layer contains a copolymer of vinylidene fluoride, tetrafluoroethylene, and hexafluoro propylene.

### CITATION LIST

### Patent Literature

PLT1: Japanese Laid-Open Patent Publication No. 2011-181386

### SUMMARY OF INVENTION

Patent Literature 1 aims to provide a nonaqueous electrolyte secondary battery, in which when the lithium nickel composite oxide is used for the positive electrode active material, gas generation caused by reaction between the positive electrode and the nonaqueous electrolyte at the time of high temperature charge and storage is suppressed.

Meanwhile, in nonaqueous electrolyte secondary batteries, more ion migration in electrodes and improvement in load characteristics are demanded.

An aspect of the present disclosure relates to a nonaqueous electrolyte secondary battery including a positive electrode having a positive electrode mixture layer, a negative electrode, and a nonaqueous electrolyte, wherein the positive electrode mixture layer includes a positive electrode active material and inactive particles, the positive electrode active material includes a lithium-containing composite oxide, an average particle size D1 of the positive electrode active material and an average particle size D2 of the inactive particles satisfy D1>D2, and a viscosity at 30° C. of the nonaqueous electrolyte is less than 2 mPa·s.

With the present disclosure, side reactions in nonaqueous electrolyte secondary batteries are suppressed, and load characteristics can be improved.

### BRIEF DESCRIPTION OF DRAWINGS

FIG. 1 is a partially cut-away plan view schematically illustrating the structure of a nonaqueous electrolyte secondary battery according to an embodiment of the present disclosure.

FIG. 2 is a cross sectional view along line X-X′ of the nonaqueous secondary battery shown in FIG. 1.

FIG. 3 is a graph showing a relation of a viscosity of the nonaqueous electrolyte and a capacity obtained in high-rate discharge.

FIG. 4 is an enlargement view of a portion of the graph of FIG. 3.

FIG. 5 is a diagram showing a log differential pore size distribution of the positive electrode mixture layer of cell A1 and cell B1 for evaluation.

### DESCRIPTION OF EMBODIMENTS

The nonaqueous electrolyte secondary battery according to the embodiment of the present disclosure includes a positive electrode having a positive electrode mixture layer, a negative electrode, and an electrolyte. The positive electrode mixture layer includes a positive electrode active material and inactive particles. The positive electrode active material includes a lithium-containing composite oxide. The average particle size D1 of the positive electrode active material and the average particle size D2 of the inactive particles satisfies D1>D2. The viscosity at 30° C. of the electrolyte is less than 2 mPa·s.

The positive electrode active material has a high hardness and can form voids of various sizes between particles of the positive electrode mixture layer even when they are densely packed. In particular, the lithium-containing composite oxide often forms generally spherical secondary particles, and therefore voids are easily formed in the positive electrode mixture layer.

On the other hand, when the positive electrode mixture layer contains the positive electrode active material and inactive particles and the average particle size D1 of the positive electrode active material and the average particle size D2 of the inactive particles satisfy D1>D2, the inactive particles fill relatively large voids between the particles of the positive electrode active material to homogenize the size of the voids. In this manner, fine paths along which lithium ions can migrate increase, and the travel distance of lithium ions contributing to the reactions in the positive electrode mixture layer decreases. As a result, the load characteristics of the nonaqueous electrolyte secondary battery improves. For example, discharge capacity improves when performing high-rate discharge.

When D1≤D2, the inactive particles cannot be expected to bring out the effects of reducing the relatively large voids between the particles of the positive electrode active material and homogenizing the size of the voids.

The inactive particles that fill between particles of the positive electrode active material do not normally contribute to the charge/discharge reactions, nor to side reactions of the nonaqueous electrolyte secondary battery. Therefore, excessive film generation due to the progress of side reactions hardly occurs, and the fine paths for lithium ion migration are hardly blocked. In addition, by suppressing side reaction, gas generation associated with the charge/discharge cycles is also suppressed.

However, the effect of improving the discharge performance (hereinafter referred to as high-rate discharge performance) when high-rate discharge is performed is an effect specific to the case where the viscosity of the nonaqueous electrolyte is low. Specifically, the viscosity at 30° C. of the nonaqueous electrolyte is required to be less than 2 mPa·s. When the viscosity at 30° C. of the nonaqueous electrolyte is 2 mPa·s or more, the discharge capacity during high-rate discharge significantly lowers. This is probably because when the viscosity of the nonaqueous electrolyte is increased to a certain extent, the liquid circulation of the nonaqueous electrolyte to the fine moving paths of lithium ions are lowered.

The lower the viscosity at 30° C. of the nonaqueous electrolyte, the more desirable, and for example, with 1.9 mPa·s or less, the improvement effect of high-rate discharge performance is significant. Furthermore, when the viscosity at 30° C. of the nonaqueous electrolyte is 1.5 mPa·s or less, and even with 1.3 mPa·s or less, improvement effects of high-rate discharge performance are even more significant.

### (Measurement of Nonaqueous Electrolyte Viscosity)

The viscosity at 30° C. of the nonaqueous electrolyte can be determined by, for example, a viscometer using a microchip-differential pressure method (e.g., Viscometer-Rheometer-on-a-Chip (m-VROC) manufactured by RheoSense, Inc.).

The positive electrode active material (particularly lithium-containing composite oxide) usually is in the form of secondary particles of coagulated primary particles. The average particle size D1 of the positive electrode active material can be, for example, 2 μm or more and 20 μm or less, or 4 μm or more and 15 μm or less.

The average particle size D2 of the inactive particles depends on the average particle size D1 of the positive electrode active material, and it can be, for example 0.1 μm or more and 10 μm or less, and 0.5 μm or more and 5 μm or less. Here, the average particle size refers to a median diameter in which the cumulative volume in volume-based particle size distribution is 50%. The volume-based particle size distribution can be measured by laser diffraction particle size distribution analyzer. By setting the average particle size D2 of the inactive particles to 0.1 μm or more, dispersiveness of the inactive particles when mixing with the positive electrode active material improves, and by setting to 10 μm or less, relatively large voids between the particles of the positive electrode active material are easily filled with the inactive particles.

The ratio of the average particle size D1 to the average particle size D2: D1/D2 may satisfy, for example, 2 to 50, or may satisfy 5 to 30. When D1/D2 is in the above-described range, relatively large voids between the particles of the positive electrode active material tend to be filled with the inactive particles and the size of the voids tends to be more homogenized.

In the positive electrode mixture layer, the amount of the inactive particles relative to a total of the positive electrode active material and inactive particles may be, for example, 0.1 mass % or more and 15 mass % or less, 0.5 mass % or more and 10 mass % or less, or 0.5 mass % or more and 5 mass % or less. In such a range, the space in the positive electrode mixture layer which is not filled with the positive electrode active material (i.e., the space which does not contribute to capacity) are likely to be filled with the inactive particles, and the space to be occupied by positive electrode active material is unlikely to be eroded by the inactive particles. Therefore, because the space that does not contribute to capacity can be effectively used, the positive electrode capacity can be secured sufficiently even when the positive electrode mixture layer includes the inactive particles.

Here, the inactive particles refer to a particle of a material substantially inactive electrochemically, to be specific, to a material having a theoretical capacity per unit mass of 10 mAh/g or less. For the inactive particles, it is desirable to use a particle of ceramics that is stable in batteries and inexpensively available. In addition, ceramic particles are advantageous over a carbon material such as carbon black used as a conductive material because it retains its shape and maintains a void in the positive electrode mixture layer easily even when it is rolled to increase the density of the positive electrode mixture layer.

Examples of the ceramics which are electrochemically inactive include silica, alumina, titania, magnesia, and zirconia. In particular, at least one selected from the group consisting of silica and alumina, and titania are preferable in view of easy availability.

The effect of improving high-rate discharge performance becomes more remarkable as the thickness of the positive electrode mixture layer increases. In other words, the greater the thickness of the positive electrode mixture layer, the greater the absolute moving distance of lithium ions, and therefore, shortening the moving distance is essential for improving load characteristics of the nonaqueous electrolyte secondary battery. Specifically, when the thickness of the positive electrode mixture layer is 100 μm or more (or even 110 μm or more or 120 μm or more), the degree of improvement in high-rate discharge characteristics due to the synergistic effects of the use of the inactive particles satisfying D1>D2 and the use of the nonaqueous electrolyte having a low viscosity of 2 mPa·s or less at 30° C. tends to be remarkable. However, in view of suppressing the decrease in the liquid flowability and allowing the above-described synergistic effects to manifest, it is desirable to set the thickness of the positive electrode mixture layer to 300 μm or less.

In order to homogenize the size of the void, it is necessary that the inactive particles of only a trace amount present in the positive electrode mixture layer efficiently fill the void. Therefore, unlike the proposal of the aforementioned Patent Literature 1, it is not necessary to attach the inactive particles to the surface of the positive electrode active material. The coverage rate Rc by the inactive particles of the positive electrode active material may be 30% or less.

The coverage rate Rc is determined from the image data of element mappings of the cross-sections of the positive electrode mixture layer. In the image data, those inactive particles present at a position away by a distance d or more from the particle surface of the positive electrode active material are not considered to be attached to the surface of the positive electrode active material, the distance d corresponding to 3% of the average particle size D1 of the positive electrode active material. Therefore, the inactive particles in a region A are considered as attached to the positive electrode active material. Here, when a curve is drawn on the image data along the positive electrode active material particle surface at a distance away by the distance d from the positive electrode active material particle surface, those inactive particles present in the region A between the curve and the positive electrode active material particle surface are defined as attached to the positive electrode active material. At this time, the ratio of area corresponding to the inactive particles existing in the region A to the total area corresponding to the inactive particles in the image data is defined as the coverage rate Rc. At this time, in the image data used, five or more particles of the positive electrode active material having a largest diameter within the average particle size D1±20% should be confirmed, and for at least two of these particles, the entire images should be confirmed.

Although the lithium-containing composite oxide is hardly packed densely in the positive electrode mixture layer, it is desired to increase the density of positive electrode mixture layer as much as possible due to the demand for high capacity. Generally, the density of the positive electrode mixture layer is set to be in a range of, for example, 2 g/cm³ or more and 4 g/cm³ or less, and for a higher density, 3 g/cm³ or more and 4 g/cm³ or less. The positive electrode mixture layer density (d) is calculated by, for example, cutting out a positive electrode piece having a predetermined size from the positive electrode, measuring the thickness (t) and area (S) of the positive electrode mixture layer of the positive electrode piece, measuring the mass (M) of the positive electrode mixture layer of the positive electrode piece, and calculating from the formula: d=M/(t×S).

The porosity of the positive electrode mixture layer is, for example 15 vol % or more, 30 vol % or less. The porosity of the positive electrode mixture layer is calculated from the apparent volume of the positive electrode mixture layer, the composition of the positive electrode mixture layer, and the absolute specific gravities of the materials contained in the positive electrode mixture layer.

Next, a nonaqueous electrolyte secondary battery according to the present disclosure will be described in detail. A nonaqueous electrolyte secondary battery includes, for example, a positive electrode, negative electrode, nonaqueous electrolyte, and separator such as below.

### [Positive Electrode]

The positive electrode has a positive electrode current collector and a positive electrode mixture layer of the above-described configuration formed on the positive electrode current collector. The positive electrode mixture layer can be formed by applying a positive electrode slurry in which a positive electrode mixture containing, for example, a positive electrode active material, inactive particles, a binder, or the like is dispersed in a dispersion medium on a surface of the positive electrode current collector and drying. The dried coating film may be rolled, if necessary. The positive electrode mixture layer may be formed on one surface of the positive electrode current collector, or may be formed on both surfaces thereof.

The positive electrode mixture layer contains a positive electrode active material as an essential component, and as an optional component, a binder, a conductive material, a thickener, or the like. For the binder, conductive material, thickener, etc., known materials can be used.

The positive electrode active material contains a lithium-containing composite oxide.

The lithium-containing composite oxide is not particularly limited, but one having a layered rock salt type crystal structure containing lithium and a transition metal is promising. Specifically, the lithium-containing composite oxide may be, for example, LiₐNi_{1-x-y}CoₓM_{y}O₂ (where 0<a≤1.2, 0≤x≤0.1, 0≤y≤0.1, 0<x+y≤0.1, and M is at least one selected from the group consisting of Na, Mg, Sc, Y, Mn, Fe, Cu, Zn, Al, Cr, Pb, Sb, and B). From the viewpoint of stabilities of the crystal structure, Al may be contained as M. Note that the value “a” indicating the molar ratio of lithium is increased or decreased by charging and discharging. Specific examples include LiNi_{0.9}Co_{0.05}Al_{0.05}O₂, LiNi_{0.91}Co_{0.06}Al_{0.03}O₂, and the like.

For the positive electrode current collector, for example, a metal sheet or metal foil is used. As the material of the positive electrode current collector, stainless steel, aluminum, aluminum alloy, titanium, and the like can be exemplified.

### [Negative Electrode]

The negative electrode has, for example, a negative electrode current collector, and a negative electrode active material layer formed on the negative electrode current collector. The negative electrode active material layer can be formed, for example, by applying a negative electrode slurry, in which a negative electrode mixture containing a negative electrode active material, a binder and the like are dispersed in a dispersion medium, on a surface of the negative electrode current collector and drying. The dried coating film may be rolled, if necessary. That is, the negative electrode active material layer can be a negative electrode mixture layer. The negative electrode active material layer may be formed on one surface of the negative electrode current collector or may be formed on both surfaces.

The negative electrode active material layer may be a lithium metal foil or lithium alloy foil. In this instance, the negative electrode current collector is not essential.

The negative electrode mixture layer contains a negative electrode active material as an essential component, and may contain a binder, a conductive agent, a thickener, and the like as an optional component. For the binder, conductive material, thickener, etc., known materials can be used.

The negative electrode active material contains a material that electrochemically stores and releases lithium ions, a lithium metal, and a lithium alloy. For the material that electrochemically stores and releases lithium ions, a carbon material, alloy based material, and the like are used. Examples of the carbon material include graphite, soft carbon, hard carbon, and the like. Preferred among them is graphite, which is excellent in stability during charging and discharging and has small irreversible capacity.

Here, the alloy based material refers to a material containing an element capable of forming an alloy with lithium. Silicon and tin are examples of the element that can form an alloy with lithium, and silicon (Si) is particularly promising.

As the material containing silicon, a silicon alloy, a silicon compound, or the like may be used, and a composite material may also be used. Among them, a composite material containing a lithium ion conductive phase and silicon particles dispersed in the lithium ion conductive phase is promising. As the lithium ion conductive phase, for example, a silicon oxide phase, silicate phase, carbon phase, or the like can be used. The silicon oxide phase has a relatively large irreversible capacity. On the other hand, the silicate phase is preferable in that its irreversible capacity is small.

The main component (e.g., 95 to 100 mass %) of the silicon oxide phase may be silicon dioxide. The composition of the composite material including the silicon oxide phase and silicon particles dispersed therein, as a whole, can be expressed as SiOₓ. SiOₓ has a structure in which fine particles of silicon are dispersed in Sift in an amorphous form. The content ratio x of oxygen to silicon is, for example, 0.5≤x≤2.0, more preferably 0.8≤x≤1.5.

The silicate phase may include, for example, at least one selected from the group consisting of Group 1 element and Group 2 element of the long-form periodic table. Examples of Group 1 element and Group 2 element of the long-form periodic table include lithium (Li), potassium (K), sodium (Na), magnesium (Mg), calcium (Ca), strontium (Sr), barium (Ba), and the like. Other element may include aluminum (Al), boron (B), lanthanum (La), phosphorus (P), zirconium (Zr), titanium (Ti), etc. In particular, the silicate phase containing lithium (hereinafter also referred to as lithium silicate phase) is preferable because of its small irreversible capacity and high initial charge/discharge efficiency.

The lithium silicate phase may be any oxide phase containing lithium (Li), silicon (Si), and oxygen (O), and may include other element. The atomic ratio of O to Si in the lithium silicate phase: O/Si is, for example, larger than 2 and less than 4. Preferably, O/Si is larger than 2 and less than 3. The atomic ratio of Li to Si in the silicate phase: Li/Si is, for example, larger than 0 and less than 4. The lithium silicate phase may have a composition represented by the formula: Li_{2z}SiO₂+z (0<z<2). Preferably, the relation 0<z<1 is satisfied, and z=½ is more preferable. Examples of the elements other than Li, Si, and O that can be contained in the lithium silicate phase include iron (Fe), chromium (Cr), nickel (Ni), manganese (Mn), copper (Cu), molybdenum (Mo), zinc (Zn), aluminum (Al), etc.

The carbon phase may be composed of, for example, an amorphous carbon with less crystallinity. The amorphous carbon may be, for example, hard carbon, soft carbon, or something else.

For the negative electrode current collector, for example, a metal sheet or metal foil is used. As the material of the negative electrode current collector, stainless steel, nickel, nickel alloy, copper, copper alloy, and the like can be exemplified.

Examples of the conductive material used for the positive electrode mixture layer and negative electrode mixture layer include carbon materials such as carbon black (CB), acetylene black (AB), Ketjen Black (KB), carbon nanotube (CNT), and graphite. A kind of the conductive material may be used singly, or two or more kinds may be used in combination.

Examples of the binder for the positive electrode mixture layer and negative electrode mixture layer include fluororesin (polytetrafluoroethylene, polyvinylidene fluoride, etc.), polyacrylonitrile (PAN), polyimide resin, acrylic resin, polyolefin resin, and the like. A kind of the binder may be used singly, or two or more kinds may be used in combination.

### [Electrolyte]

The nonaqueous electrolyte includes a nonaqueous solvent and a solute dissolved in the nonaqueous solvent. The solute here means an electrolytic salt whose ions dissociate in nonaqueous solvents and examples thereof include lithium salts. Components of the nonaqueous electrolyte other than the nonaqueous solvent and solute is additives. The electrolyte may contain various additives.

For the nonaqueous solvent, for example, cyclic carbonate, chain carbonate, cyclic carboxylate, chain carboxylate, and the like are used. Examples of the cyclic carbonate include propylene carbonate (PC), ethylene carbonate (EC), and vinylene carbonate (VC). Examples of the chain carbonate include diethyl carbonate (DEC), ethyl methyl carbonate (EMC), and dimethyl carbonate (DMC). Examples of the cyclic carboxylate include γ-butyro lactone (GBL) and γ-valerolactone (GVL). Examples of the chain carboxylate include methyl acetate, ethyl acetate, propyl acetate, methyl propionate (MP), ethyl propionate (EP), and the like. A kind of nonaqueous solvent may be used singly, or two or more kinds thereof may be used in combination.

Of these examples, the chain carboxylate is suitable for preparation of a low viscosity nonaqueous electrolyte. Thus, the nonaqueous electrolyte may contain 90 mass % or less of the chain carboxylate. Among the chain carboxylate, methyl acetate has a particularly low viscosity. Therefore, 90 mass % or more of the chain carboxylate may be methyl acetate.

Examples of the nonaqueous solvent also include cyclic ethers, chain ethers, nitriles such as acetonitrile, and amides such as dimethylformamide.

Examples of the cyclic ether include 1,3-dioxolane, 4-methyl-1,3-dioxolane, tetrahydrofuran, 2-methyl tetrahydrofuran, propylene oxide, 1,2-butylene oxide, 1,3-dioxane, 1,4-dioxane, 1,3,5-trioxane, furan, 2-methyl-furan, 1,8-cineol, and crown ether.

Examples of the chain ether include 1,2-dimethoxyethane, dimethyl ether, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxy benzene, 1,2-diethoxyethane, 1,2-dibutoxy ethane, diethylene glycol dimethylether, diethylene glycol diethyl ether, diethylene glycol dibutyl ether, 1,1-dimethoxy methane, 1,1-diethoxy ethane, triethylene glycol dimethylether, tetraethylene glycol dimethyl ether, and the like.

These solvents may be a fluorinated solvent in which hydrogen atoms are partially substituted with fluorine atoms. Fluoro ethylene carbonate (FEC) may be used as the fluorinated solvent.

Examples of the lithium salt include a lithium salt of chlorine containing acid (LiClO₄, LiAlCl₄, LiB₁₀Cl₁₀, etc.), a lithium salt of fluorine containing acid (LiPF₆, LiPF₂O₂, LiBF₄, LiSbF₆, LiAsF₆, LiCF₃SO₃, LiCF₃CO₂, etc.), a lithium salt of fluorine containing acid imide (LiN(FSO₂)₂, LiN(CF₃SO₂)₂, LiN(CF₃SO₂)(C₄F₉SO₂), LiN(C₂F₅SO₂)₂, etc.), a lithium halide (LiCl, LiBr, LiI, etc.), and the like. A kind of lithium salt may be used singly, or two or more kinds thereof may be used in combination.

The concentration of the lithium salt in the nonaqueous electrolyte may be 1 mol/liter or more and 2 mol/liter or less, or may be 1 mol/liter or more and 1.5 mol/liter or less. By controlling the concentration of lithium salt to be in the above-described range, a nonaqueous electrolyte having excellent ion conductivity and low viscosity can be obtained.

Examples of the additive include 1,3-propanesultone, methyl benzene sulfonate, cyclohexylbenzene, biphenyl, diphenyl ether, and fluoro benzene.

### [Separator]

A separator is interposed between the positive electrode and the negative electrode. The separator has excellent ion permeability and suitable mechanical strength and electrically insulating properties. The separator may be, for example, a microporous thin film, a woven fabric, or a nonwoven fabric. The separator is preferably made of, for example, polyolefins such as polypropylene and polyethylene.

In an example structure of a secondary battery, an electrode group and a nonaqueous electrolyte are accommodated in an outer package, the electrode group having a positive electrode and a negative electrode wound with a separator. Alternatively, instead of the wound electrode group, other forms of electrode group may be applied, such as a laminated electrode group in which a positive electrode and a negative electrode are laminated with a separator interposed. The nonaqueous electrolyte secondary battery may be in any form, e.g., cylindrical, prismatic, coin-shaped, button-shaped, laminated, etc.

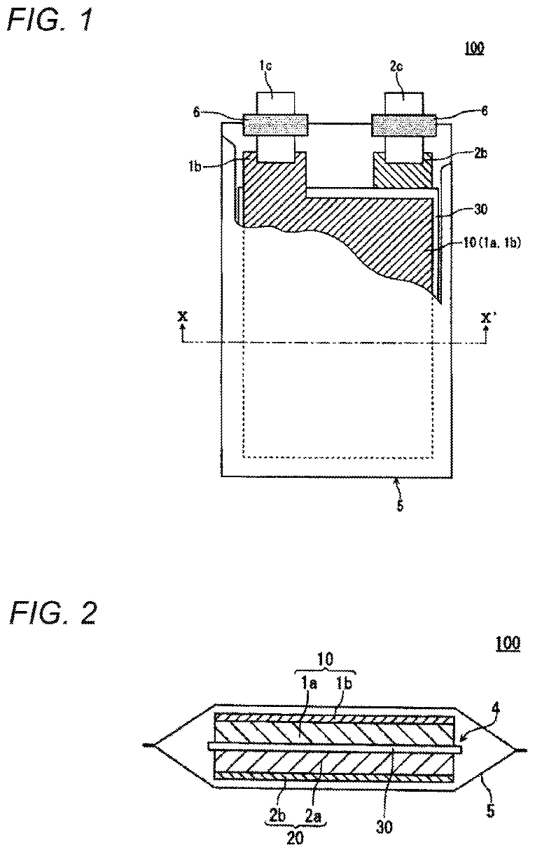

Referring to FIG. 1 and FIG. 2, a nonaqueous electrolyte secondary battery according to an embodiment of the present disclosure will be described below. FIG. 1 is a partially cut-away plan view schematically showing an exemplary nonaqueous electrolyte secondary battery structure. FIG. 2 is a cross sectional view along line X-X′ in FIG. 1.

As shown in FIG. 1 and FIG. 2, a nonaqueous electrolyte secondary battery 100 is a sheet type battery, and includes an electrode group 4 and an outer case 5 for accommodating the electrode group 4.

The electrode group 4 has a structure in which a negative electrode 10, a separator 30, and a positive electrode 20 are laminated in this order, and the negative electrode 10 faces the positive electrode 20 with the separator 30 interposed therebetween. The electrode group 4 is formed in this manner. The electrode group 4 is impregnated with a nonaqueous electrolyte.

The negative electrode 10 includes a negative electrode active material layer 1a and a negative electrode current collector 1b. The negative electrode active material layer 1a is formed on the surface of the negative electrode current collector 1b.

The positive electrode 20 includes a positive electrode mixture layer 2a and a positive electrode current collector 2b. The positive electrode mixture layer 2a is formed on the surface of the positive electrode current collector 2b.

A negative electrode tab lead 1c is connected to the negative electrode current collector 1b, and positive electrode tab lead 2c is connected to the positive electrode current collector 2b. Each of the negative electrode tab lead 1c and the positive electrode tab lead 2c extends to the outside of the outer case 5.

The negative electrode tab lead 1c is insulated from the outer case 5, and the positive electrode tab lead 2c is insulated from the outer case 5 by an insulating tab film 6.

In the following, the present disclosure will be specifically described based on Examples and Comparative Examples, but the present disclosure is not limited to Examples below.

### Example 1

### (1) Production of Positive Electrode

A positive electrode active material, inactive particles, a conductive material, and a binder were mixed at a mass ratio of 100:1.6:0.75:0.6, N-methyl-2-pyrrolidone (NMP) was added thereto, and the mixture was stirred to prepare a positive electrode slurry. Next, a coating film was formed by applying the positive electrode slurry on one side of the positive electrode current collector. An aluminum foil was used for the positive electrode current collector. After drying the coating film, the coating film was rolled together with the positive electrode current collector by a roller to obtain a positive electrode having a positive electrode mixture layer having a thickness of 120 to 130 μm, a density of 3.7 g/cm, and a porosity of 22%.

The positive electrode was cut into a predetermined shape to obtain a positive electrode for evaluation. The positive electrode was provided with a region of 20 mm×20 mm functioning as a positive electrode and a region of 5 mm×5 mm for connecting with the tab lead. Thereafter, the positive electrode mixture layer formed on the above-described connecting region was scraped to expose the positive electrode current collector. Afterwards, the exposed portion of the positive electrode current collector was connected to the positive electrode tab lead and a predetermined region of the outer periphery of the positive electrode tab lead was covered with an insulating tab film.

The following was used as the materials.

Positive electrode active material: LiNi_{0.9}Co_{0.05}Al_{0.05}O₂ (average particle size D1=11.1 μm)

Inactive particles: alumina (Al₂O₃) (average particle size D2=0.79 μm, D1/D2 ratio=14.1)

Conductive material: acetylene black

Binder: polyvinylidene fluoride

### (2) Production of Negative Electrode

A negative electrode was produced by attaching a lithium metal foil (thickness 300 μm) on one side of an electrolytic copper foil.

The negative electrode was cut into the same form as the positive electrode, and a negative electrode for evaluation was obtained. The lithium metal foil formed on the connecting region formed in the same manner as the positive electrode was peeled off to expose the negative electrode current collector. Afterwards, the exposed portion of the negative electrode current collector was connected to the negative electrode tab lead in the same manner as the positive electrode, and a predetermined region of the outer periphery of the negative electrode tab lead was covered with an insulating tab film.

### (3) Preparation of Nonaqueous Electrolyte

To the solvent mixture of the compositions (volume ratio) shown in Table 1, LiPF₆ was dissolved at a concentration of 1 mol/L to prepare a nonaqueous electrolyte. The viscosity at 30° C. of the nonaqueous electrolyte was measured by a Viscometer-Rheometer-on-a-Chip (m-VROC (registered trademark) manufactured by RheoSense Inc., under the conditions of a channel depth of 50 μm and a shear rate of 4000 to 10000s⁻¹. For the viscosity at 30° C., the average viscosity in the measuring region, in which the %-Full-scale of the parameter was 20% or more, was used. Table 1 shows the result.

The following was used as the nonaqueous solvent.

FEC: fluoro ethylene carbonate

DMC: dimethyl carbonate

MA: methyl acetate

### (4) Preparation of Cell for Evaluation

Using the above-described positive electrode and negative electrode for evaluation, a cell was produced. First, the positive electrode and negative electrode were allowed to face each other with a polypropylene made separator (thickness 30 μm) so that the positive electrode mixture layer overlaps with the negative electrode mixture layer (lithium metal foil), thereby producing an electrode group. Next, an Al laminate film (thickness 100 μm) cut into a rectangle of 60×90 mm was folded in half, and a long side end of 60 mm was heat-sealed at 230° C. to form an envelope of 60×45 mm. Afterwards, the fabricated electrode group was put into the envelope, and heat-sealing at 230° C. was performed, aligning the position of the thermal welding resin of respective tab leads with the end face of the Al laminate film. Next, 0.3 cm³ of the nonaqueous electrolyte was injected from the not heat-sealed portion of the short side of the Al laminate film, and after the injection, they were allowed to stand for 5 minutes under a reduced pressure of 0.06 MPa to impregnate the positive electrode mixture layer with the nonaqueous electrolyte. Finally, the end face of the liquid-injected side of the Al laminate film was heat-sealed at 230° C. to obtain a cell A1 for evaluation. The evaluation cell was prepared in a dry air atmosphere having a dew point of −50° C. or less.

### (5) Battery Evaluation

The evaluation cell was sandwiched between a pair of 80×80 cm stainless steel (thickness 2 mm) plates and fixed under a pressure of 0.2 MPa.

First, in a thermostatic chamber at 25° C., a cycle of charging and discharging was performed 5 times at a constant current of 0.05 C (1 C being an electric current to discharge the designed capacity by 1 hour). Charging was terminated at a battery voltage of 4.2 V, and discharging was terminated at a battery voltage of 2.5 V, respectively, and the batteries were allowed to stand for 20 minutes with an open circuit between the charging and discharging.

Then, the batteries were charged in a thermostatic chamber at 25° C. with a constant current of 0.05 C to 4.2 V and held at a constant voltage of 4.2 V until the electric current reached less than 1 mA. After allowing the batteries to stand for 20 minutes in an open circuit, they were discharged to 2.5 V with a constant current of 2 C in a thermostatic chamber of 25° C., and 2 C discharge capacity was determined as high-rate discharge performance.

Table 1 shows the results. The 2C discharge capacity of Table 1 is a relative value relative to a cell B3 of Comparative Example 3 described later, and the larger the better high-rate discharge performance.

### Example 2

A cell A2 for evaluation was produced in the same manner as in Example 1, except that in the preparation of the nonaqueous electrolyte, the composition of the mixed solvent was changed as shown in Table 1.

### Example 3

A cell A3 for evaluation was produced in the same manner as in Example 1, except that in the preparation of the positive electrode, the average particle size D2 of alumina (Al₂O₃) was changed to 2.85 μm (D1/D2 ratio=3.9). The packing amount and the porosity of the positive electrode active material contained in the positive electrode mixture layer were controlled to be the same as those of Example 1.

### Example 4

A cell A4 for evaluation was produced in the same manner as in Example 3, except that in the preparation of the nonaqueous electrolyte, the composition of the mixed solvent was changed to the composition shown in Table 1.

### Comparative Example 1

A cell B1 for evaluation was produced in the same manner as in Example 1, except that alumina (Al₂O₃) was not added to the positive electrode mixture layer in the preparation of the positive electrode. The packing amount and the porosity of the positive electrode active material contained in the positive electrode mixture layer were controlled to be the same as those of Example 1.

### Comparative Example 2

A cell B2 for evaluation was produced in the same manner as in Example 2, except that alumina (Al₂O₃) was not added to the positive electrode mixture layer in the preparation of the positive electrode. The packing amount and the porosity of the positive electrode active material contained in the positive electrode mixture layer were controlled to be the same as those of Example 1.

### Comparative Example 3

A cell B3 for evaluation was produced in the same manner as in Comparative Example 1, except that in the preparation of the nonaqueous electrolyte, the composition of the mixed solvent was changed to the composition shown in Table 1.

### Comparative Example 4

A cell B4 for evaluation was produced in the same manner as in Example 1, except that in the preparation of the nonaqueous electrolyte, the composition of the mixed solvent was changed to the composition shown in Table 1.

### Comparative Example 5

A cell B5 for evaluation was produced in the same manner as in Example 3, except that in the preparation of the nonaqueous electrolyte, the composition of the mixed solvent was changed to the composition shown in Table 1.

TABLE 1

| | | | | | | | 2C Discharge |
|---|---|---|---|---|---|---|---|
| | Alumina D2 | FEC | DMC | MA | MA* | Viscosity | capacity |
| | (μm) | (vol %) | (vol %) | (vol %) | (mass %) | (mPa · s) | (Relative value) |
| A1 | 0.79 | 20 | 0 | 80 | 72 | 1.22 | 4.54 |
| A2 | 0.79 | 20 | 70 | 10 | 8 | 1.85 | 1.24 |
| A3 | 2.85 | 20 | 0 | 80 | 72 | 1.22 | 4.05 |
| A4 | 2.85 | 20 | 70 | 10 | 8 | 1.85 | 1.27 |
| B1 | Not added | 20 | 0 | 80 | 72 | 1.22 | 2.45 |
| B2 | Not added | 20 | 70 | 10 | 8 | 1.85 | 1.13 |
| B3 | Not added | 20 | 80 | 0 | 0 | 2 | 1 |
| B4 | 0.79 | 20 | 80 | 0 | 0 | 2 | 0.98 |
| B5 | 2.85 | 20 | 80 | 0 | 0 | 2 | 0.94 |

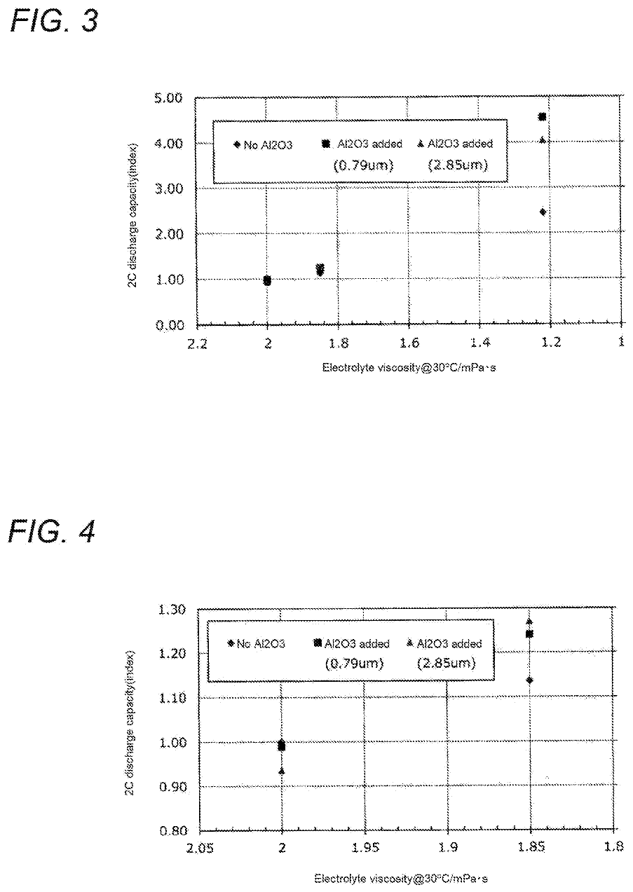

FIG. 3 shows the relation between the viscosity of the nonaqueous electrolyte and the 2C discharge capacity. FIG. 4 shows an enlarged view of the area surrounded by the broken line in FIG. 3. It can be seen from FIG. 3 that when the positive electrode mixture layer contains inactive particles, the 2C discharge capacity increases significantly as the viscosity of the nonaqueous electrolyte decreases. On the other hand, when the positive electrode mixture layer does not contain the inactive particles, it can be seen that with the decrease in the viscosity of the nonaqueous electrolyte, although the 2C discharge capacity increases to some extent, the increase is relatively very small.

In FIG. 3, since the 2C discharge capacity increases very significantly when the viscosity of the nonaqueous electrolyte is 1.22 mPa·s, it is difficult to grasp the tendency of the area surrounded by the broken line. In this regard, FIG. 4 shows that the 2C discharge capacity is significantly increased even when the viscosity of the nonaqueous electrolyte is 1.85 mPa·s, compared with the case where the viscosity is 2.0 mPa·s.

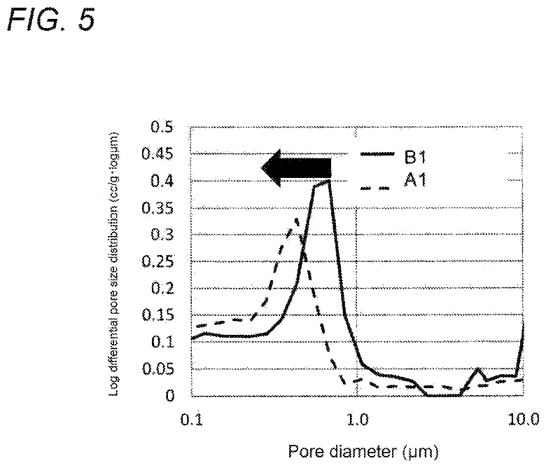

Next, with respect to the positive electrode mixture layer of the cell A1 for evaluation of Example 1 and the positive electrode mixture layer of the cell B1 for evaluation of Comparative Example 1, the respective log differential pore size distributions (cc/g·log μm) were measured using a mercury porosimeter (AutoPore V of Micromeritics Instrument Corporation). The results are shown in FIG. 5. FIG. 5 shows that by adding the inactive particles, peak of the pore size distribution of the positive electrode mixture layer is shifted toward the smaller particle size, and the amount of finer pores is increased. This indicates that the relatively large voids between the positive electrode active material particles were filled with the inactive particles, and the size of the voids was homogenized, and the fine paths through which lithium ions can move increased.

### INDUSTRIAL APPLICABILITY

The nonaqueous electrolyte secondary battery according to present disclosure is suitably used in a field in which high-rate discharge performance is required.

### REFERENCE SIGNS LIST

1a Negative Electrode Active Material Layer
1b Negative Electrode Current Collector
1c Negative Electrode Tab Lead
2a Positive Electrode Mixture Layer
2b Positive Electrode Current Collector
2c Positive Electrode Tab Lead
4 Electrode Group
5 Outer Case
6 Insulating Tab Film
10 Negative Electrode
20 Positive Electrode
30 Separator
100 Lithium Ion Secondary Battery

1. A nonaqueous electrolyte secondary battery comprising a positive electrode having a positive electrode mixture layer, a negative electrode, and a nonaqueous electrolyte, wherein
the positive electrode mixture layer includes a positive electrode active material and inactive particles,
the positive electrode active material includes a lithium-containing composite oxide,
an average particle size D1 of the positive electrode active material and an average particle size D2 of the inactive particles satisfy D1>D2, and
a viscosity at 30° C. of the nonaqueous electrolyte is less than 2 mPa·s.

2. The nonaqueous electrolyte secondary battery of claim 1, wherein the viscosity at 30° C. of the nonaqueous electrolyte is 1.9 mPa·s or less.

3. The nonaqueous electrolyte secondary battery of claim 1, wherein the average particle size D2 is 0.1 μm or more and 10 μm or less.

4. The nonaqueous electrolyte secondary battery according to claim 1, wherein a ratio: D1/D2 of the average particle size D1 to the average particle size D2 satisfies 2 to 50.

5. The nonaqueous electrolyte secondary battery according to claim 1, wherein an amount of the inactive particles relative to a total of the positive electrode active material and the inactive particles is 0.1 mass % or more and 15 mass % or less.

6. The nonaqueous electrolyte secondary battery according to claim 1, wherein the inactive particles are ceramics.

7. The nonaqueous electrolyte secondary battery according to claim 6, wherein the ceramics include at least one selected from the group consisting of silica, alumina, and titania.

8. The nonaqueous electrolyte secondary battery according to claim 1, wherein a thickness of the positive electrode mixture layer is 100 μm or more.
